(19) United States
(12) Patent Application Publication
(10) Pub. No.: US 2011/0036256 A1
(43) Pub. Date: Feb. 17, 2011

(54) PRINT SETUP DEVICE, PRINT SETUP METHOD, AND COMPUTER READABLE RECORDING MEDIUM STORING PRINT SETUP PRORAM

(75) Inventor: Tamotsu SAKURABA, Sagamihara-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/852,765

(22) Filed: Aug. 9, 2010

(30) Foreign Application Priority Data
Aug. 11, 2009 (JP) 2009-186609

(51) Int. Cl. B41F 33/00

(52) U.S. Cl. 101/482; 101/483

(57) ABSTRACT

A print setup device that causes the values of items related to a print color to be applied to a second tab sheet (e.g., subchapter tab sheet) to be matched with the values of items related to a print color to be applied to a first tab sheet (e.g., chapter tab sheet) used for a first segmentation unit (e.g., “chapter”) that comprises a second segmentation unit (e.g., “subchapter”) for which said second tab sheet is used.

### CROSS-REFERENCE TO RELATED APPLICATION

This application is based on Japanese Patent Application No. 2009-186609, filed on Aug. 11, 2009, the contents of which are incorporated herein by reference.

### BACKGROUND

1. Technical Field

The present invention relates to a print setup device, print setup method, and a computer readable recording medium stored with a pint setup program.

2. Description of Related Art

There exist printing apparatuses that are capable of creating printed products by inserting between pages a tab sheet having a flat rectangular main body and a tab protruding at a specified position on a side of said may body. See Japanese Patent Publication No. 2008-9598. This printing device can print index characters on the tab of a tab sheet; moreover it can prepare a tab sheet with a desired color by printing a background color on the tab sheet.

Meanwhile, when a document consists of chapters and subchapters, it is preferable to be able to insert tab sheets at page positions indicating “chapter” breaks and also at page positions indicating “subchapter” breaks of the document.

However, if a group of chapter tab sheets used for “chapter” breaks and a group of subchapter tab sheets used for “subchapter” breaks are used in combination at the same time, it will be difficult for a user to grasp the composition of the document at glance.

On the other hand, the technology described in the above-mentioned patent document 1 has no consideration for the method using tab sheets for a plurality of purposes, e.g., the chapter tab sheet and the subchapter tab sheet, so it does not provide a means for solving the above-mentioned problem.

### SUMMARY

To achieve at least one of the above-mentioned objects, the print setup device reflecting an aspect of the present invention comprises a print color input section and a control section.

The print color input section accepts a user's instruction to set up items related to print colors to be applied to each first tab sheet of a first tab sheet group to be used in order to segment a document by a first segmentation unit.

The control section executes an identical color setup control in order to match an item value related to the print color to be applied to second tab sheets of a second tab sheet group with an item value related to the print color to be applied to the first tab sheets used for the first segmentation unit that comprises a second segmentation unit for which the second tab sheets are used; wherein the second tab sheet group is used for segmenting the document by the second segmentation unit, which is a segmentation unit finer than the first segmentation unit.

It is preferable that the above-mentioned setup device further comprises an identical color specifying section to receive a user's instruction for setting up the print color to be applied to said second tab sheets to a color identical to the print color applied to the first tab sheets, that are used for the first segmentation unit; the first segmentation unit comprising the second segmentation unit for which the second tab sheets are used. It is preferable that when the user's instruction is received at the identical color specifying section, the control section executes the identical color setup control.

It is preferable that, in the above-mentioned print setup device, the items related to said print color include at least one of the colors, which include a color of characters to be printed on the tab of the tab sheet, a background color to be printed on the tab of the tab sheet, and a frame color to be printed on the tab of the tab sheet.

It is preferable that, in the print setup device, the first segmentation unit is a chapter, and the second segmentation unit is a subchapter.

The objects, features, and characteristics of this LO invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall constitution of a network system according to an embodiment of the present invention.

FIG. 2 is a block diagram showing the constitution of the PC shown in FIG. 1.

FIG. 3 is a block diagram showing the constitution of the printer controller of the printing system shown in FIG. 1.

FIG. 4 is a block diagram showing the constitution of the printer of the printing system shown in FIG. 1.

FIG. 5 is a diagram schematically showing the constitution of a printing section.

FIG. 6 is a diagram showing an example of a tab sheet group.

FIG. 7 is a flow chart showing the procedure of the process on the PC.

FIG. 8 is a diagram showing an example of a tab sheet detail setup screen to be provided for the user in the tab sheet setup process.

FIG. 9 is a diagram showing an example of a tab sheet insertion setup screen to be provided for the user in the tab sheet setup process.

FIG. 10 is a flowchart showing the procedure of a tab print color setup process, which is a process of setting up a print color to be applied to a tab sheet.

FIG. 11 is a diagram showing an example of the tab sheet information table.

FIG. 12 is a diagram showing an example of tab sheet setup information.

FIG. 13 is a flowchart showing the procedure of the process on the printer controller.

FIG. 14 is a flowchart showing the procedure of the process on the printer.

FIG. 15 is a diagram showing an example of print output result when the colors of the chapter tab sheets and of the subchapter tab sheets used in the same “chapter” are set to an identical color.

FIG. 16 is a diagram showing an example of print output result when the print color to be applied to the same type of tab sheets is set to an identical color.

### DETAILED DESCRIPTION

The embodiment of this invention will be described below with reference to the accompanying drawings.

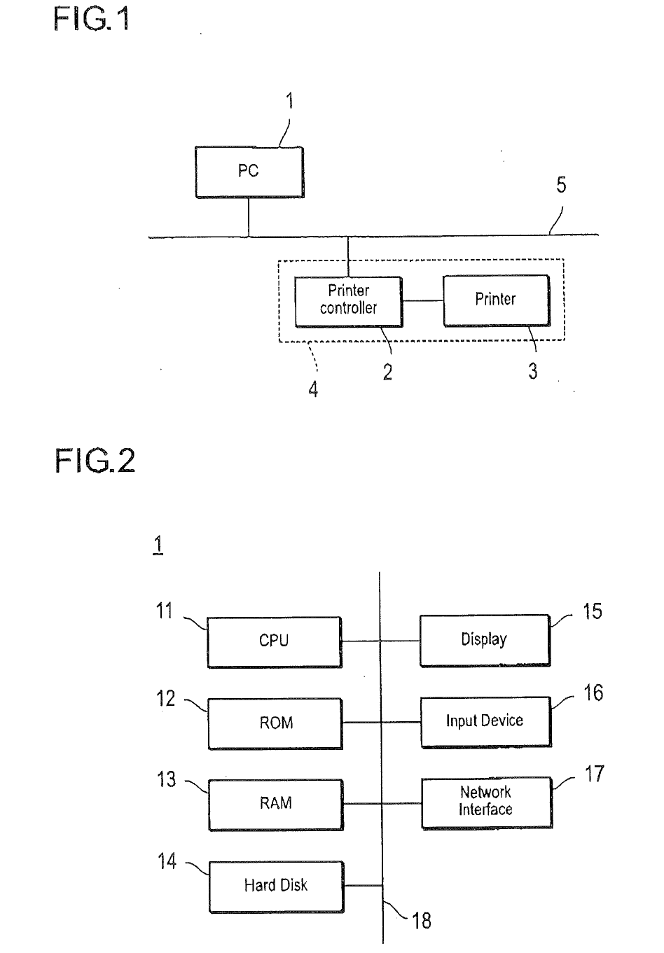

FIG. 1 is a block diagram showing the overall constitution of a network system according to an embodiment, of the present invention.

The network system related to this embodiment is equipped with a PC 1 as a print setup device for instructing the printing of a document and a printing system 4 that performs printing based on the printing instructions of the PC 1, which are connected with each other via a network 5. Also, the PC 1 and the printing system 4 can be connected directly (local connection) without recourse to the network 5.

The printing system 4 consists of a printer controller 2 and a printer 3 as an image forming apparatus, which are locally connected with each other. This local connection can be accomplished by means of various local connection interfaces, including serial interfaces such as IEEE 1394, USB and, SCSI, parallel interfaces such as IEEE 1284, wireless communication interfaces such as Bluetooth®, IEEE 802.11, HomeRF, IrDA, etc. However, the printer controller 2 and the printer 3 can be connected via the network 5.

FIG. 2 is a block diagram showing the constitution of PC 1 shown in FIG. 1.

The PC 1 comprises CPU 11, ROM 12, RAM 13, hard disk 14, display 15, input apparatus 16 and network interface 17, all of which are interconnected via bus 18 for exchanging signals.

The CPU 11 controls various parts described above and performs various arithmetic processes according to a program. The ROM 12 stores various programs and data. The RAM 13 stores programs and data temporarily as a working area. The hard disk 14 stores various programs including an operating system and data.

The hard disk 14 stores an application program for generating document files as well as a printer driver for converting the document files into PDL data described in a Page Description Language (“PDL”) decoded by the printing system 4. The printer driver provides instructions for printing document files prepared by using applications, for setting up printing output conditions, and for setting up tab sheet related matters. The printer driver contains programs for executing these setups.

The display 15 can be LCD, CRT, and other types of displays, on which various kinds of information are displayed. The input device 16 includes a pointing device such as a mouse, a keyboard, and others, and it is used for entering various kinds of information.

The network interface 17 is an interface for communicating with other equipment on the network via the network 5 utilizing the communication standards such as Ethernet®, Token Ring, FDDI, etc.

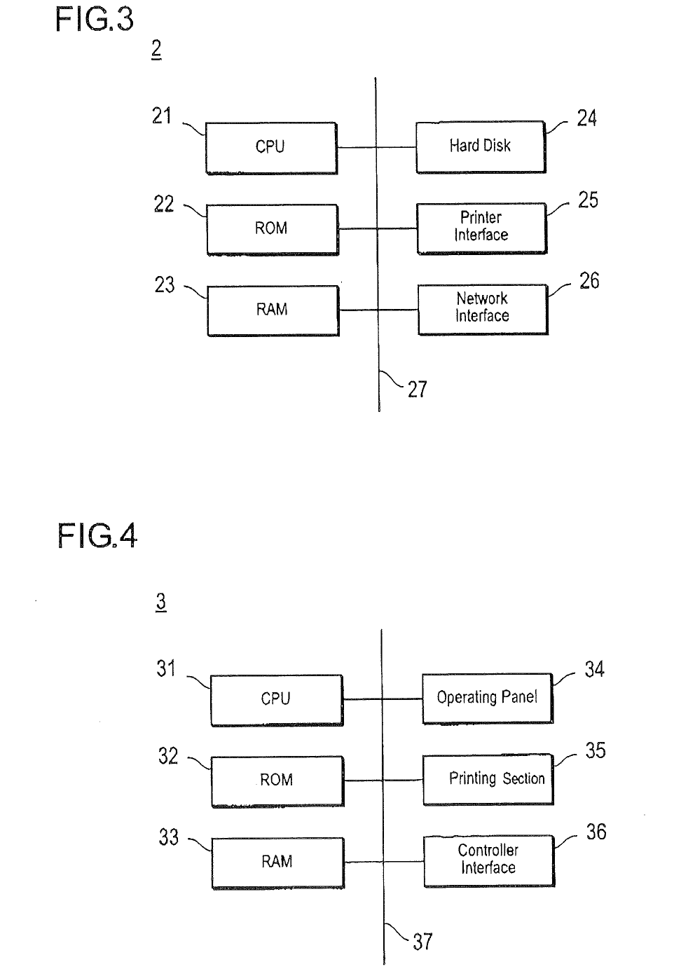

FIG. 3 is a block diagram showing the constitution of the printer controller 2 of the printing system 4 shown in FIG. 1.

The printer controller 2 is provided with CPU 21, ROM 22, RAM 23, hard disk 24, printer interface 25, and network interface 26, all of which are interconnected with each other via a bus 27 for exchanging signals. The descriptions of those parts of the printer controller 2 that have the same functions as those of the corresponding parts of the PC 1 will be omitted hereafter to avoid duplication.

The ROM 22 or hard disk 24 stores a program for the rasterization process to translate the PDL data received from PC1 and develop them into the bitmap data which are the bitmap image data, as well as a program for an image data process to analyze the received PDL data. The received PDL data and the bitmap data can be saved on the hard disk 24.

The printer interface 25 is an interface for communicating with the locally connected printer 3.

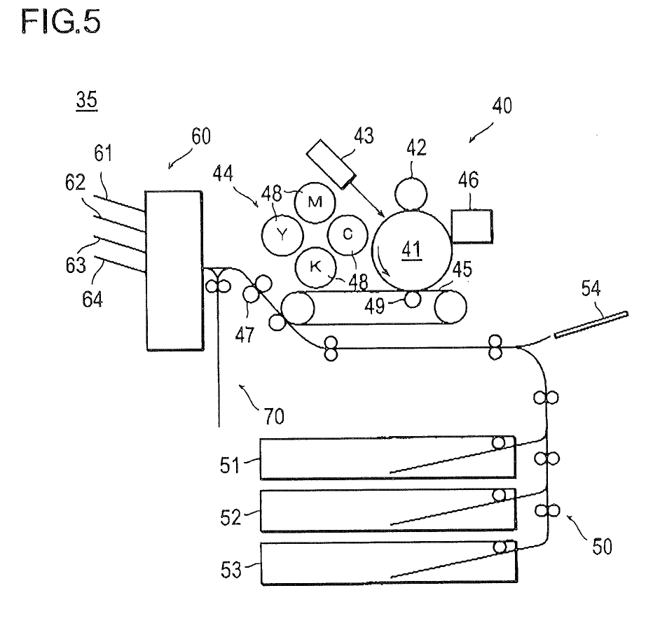

FIG. 4 is a block diagram showing the constitution of the printer 3 of the printing system 4 shown in FIG. 1. The printer 3 has CPU 31, ROM 32, RAM 33, operation panel 34, printing section 35, and controller interface 36, all of which are interconnected with each other via a bus 37 for exchanging signals. The descriptions of those parts of the printer 3 that have the same functions as those of the corresponding parts of the PC 1 will be omitted to avoid duplication.

The ROM 32 stores a printing process program to be executed based on print data containing bitmap data received from the printer controller 2.

The operating panel section 34 is equipped with a touch panel, a ten-key pad, a start button, a stop button and others to be used for displaying various data and entering various instructions.

The printing section 35 prints images on recording media such as paper based on the bitmap data received from the printer controller 2 using a publicly known image process such as the electronic photography process. The controller interface 36 is an interface for communicating with the locally connected printer controller 2.

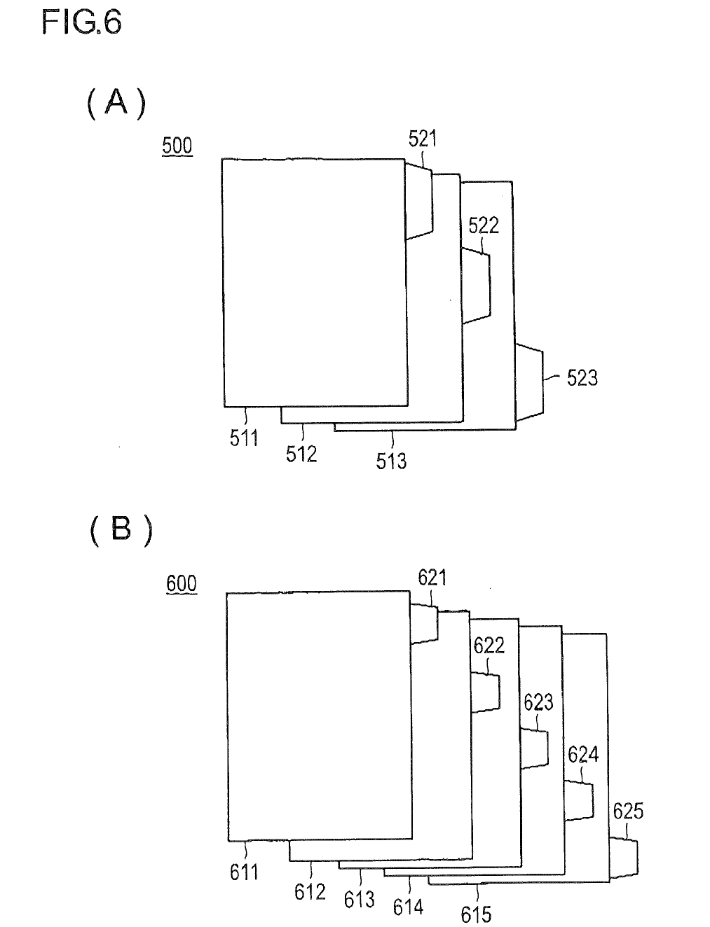

FIG. 5 is a diagram schematically showing the constitution of a printing section 35.

The printing section 35 has a paper supply section 50 for supplying recording media such as printing paper and insertion sheets such as tab sheets, an image forming section 40 for forming images on the recording media, and a paper output section 60 for extracting printing paper and tab sheets. Also, the printing section 35 has a reversing mechanism section 70 for reversing the front and back sides of printing paper.

The image forming section 40 of the printing section 35 has a photosensitive drum 41 that rotates in the arrow direction, a charging device 42, an exposing device 43, a developing device 44, an intermediate transfer belt 45, a cleaning device 46, and a fuser 47. After the surface of the photosensitive drum 41 is evenly charged by the charging device 42, an electrostatic latent image is formed on the surface of the photosensitive drum 41 as it is exposed with laser beams by the exposing device 43. The electrostatic latent image becomes visualized as the photosensitive drum 41 rotates and the toner adheres to the electrostatic latent image on the photosensitive drum 41. The developing device 44 has a developing roller 48 for each of the colors, cyan (C), magenta (M), yellow (Y), and black (K). And, visualized toner images for each of these colors are transferred to the transfer section 49 then onto the intermediate transfer belt 45 and overlaid on top of each other thereon. As a result, the overlaid color, images are transferred to the printing paper supplied from the paper supply section 50. The toner images are then fused on the printing paper in the fuser 47 and transported to the paper output section 60.

The paper supply section 50 has a plurality of sheet supply trays 51-54. The sheet supply tray 54 is a manual feed sheet supply tray. On the other hand, paper output section 60 is equipped with a plurality of sheet output trays 61-64. The sheet output section 60 may have a finishing process section for providing finishing processes such as punching or stapling to the printing paper transported thereto.

FIG. 6 shows an example of the tab sheet group, wherein (A) showing a three-tab sheet group 500, and (B) showing a five-tab sheet group 600. Tab sheets are also called index sheets. As shown in FIG. 6(A), the tab sheet group 500 is a set of tab sheets consisting as three constituents of three sheets 511-513 and is called a “three tab.” Each of the tab sheets 531-513 has a flat rectangular main body and a tab 521-523 protruding at a certain position on a side of said may body. As shown in FIG. 6(B), the tab sheet group 600 is a set consisting as five constituents of five sheets 611-615 and is called a “five-tab.” Each of the tab sheets 611-615 has a flat rectangular main body and a tab 621-625 protruding at a certain position on a side of said may body.

The order of the tab sheets shown in FIG. 6 is called the regular order and is arranged such that the tab of an upper layer sheet is set at the upper level of the tab of a lower layer sheet in FIG. 6 when the tabs are placed on the right side of the main body. For the three-tab sheet group 500, the tabs 521-523 are arranged on one side of the main body lowering their positions serially in three levels from top to bottom. Here, the positions of the tabs 521, 522, and 523 are referred to as 1/3, 2/3, and 3/3, respectively. For the five-tab sheet group 600, the tabs 621-625 are arranged on one side of the main body lowering their positions serially in five levels from top to bottom. Here, the positions of the tabs 621, 622, 623, 624, and 625 are referred to as 1/5, 2/5, 3/5, 4/5, and 5/5, respectively. The tab sheet groups 500 and 600 are normally provided in multiple sets and set in the sheet supply tray.

Next, the operation of the network system in this embodiment will be described in the following.

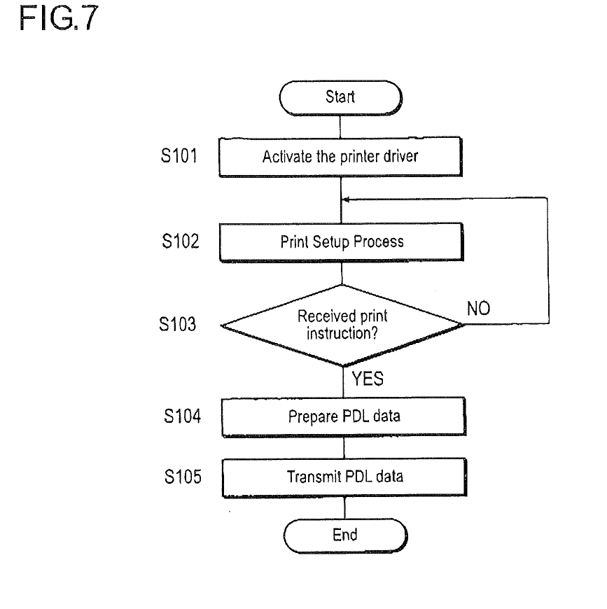

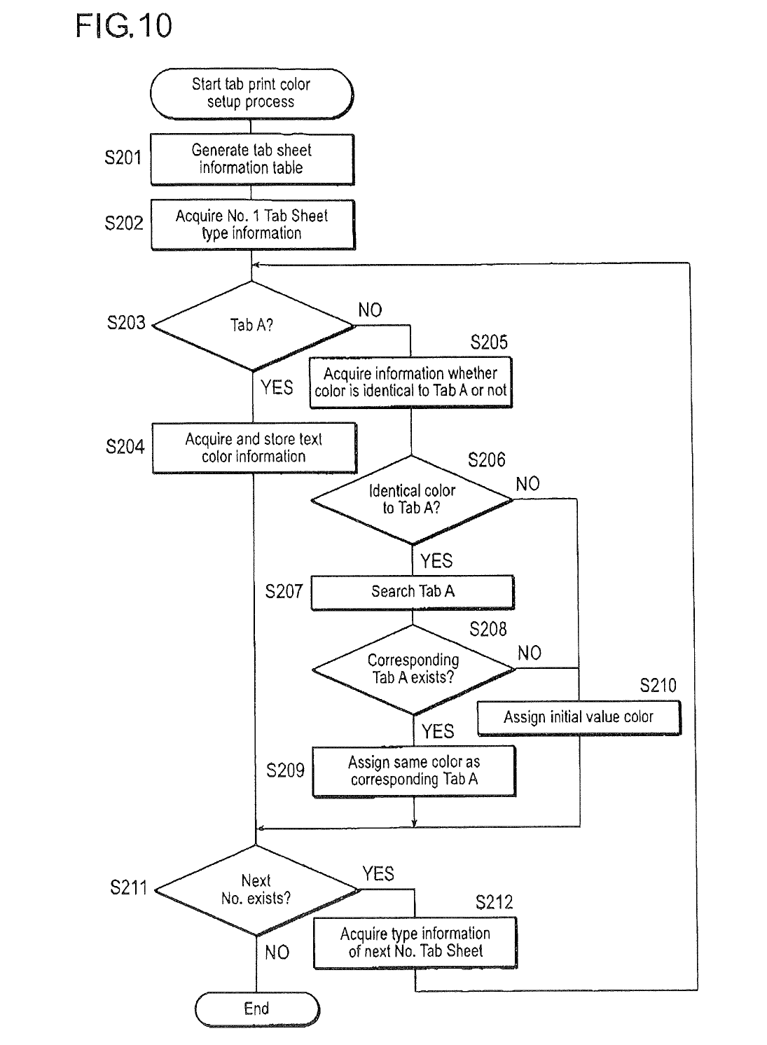

FIG. 7 is a flow chart showing the procedure of the process on the PC 1. The algorithm shown in the flowchart of FIG. 7 is stored as a program in a memory section such as a hard disk 14 of the PC 1 and executed by the CPU 11 after, read out onto RAM 13 (same as FIG. 10).

It is presumed that a document file to be printed is created on the PC 1. The document file is created by an application installed in the PC 1.

As shown in FIG. 7, when performing a printing process for a document file, the printer driver is activated via printing setup dialogs of the application based on the user's operation (S101).

Then, a print setup screen (not shown) is displayed on the display 15 by the printer driver, and the print setup process is performed via the print setup screen (S102). For example, print setup processes such as specification of paper size, finishing process such as stapling, etc. are performed. As a part of the print setup process, the setup process for tab sheets is performed as well. The setup process for tab sheets will be described below in detail.

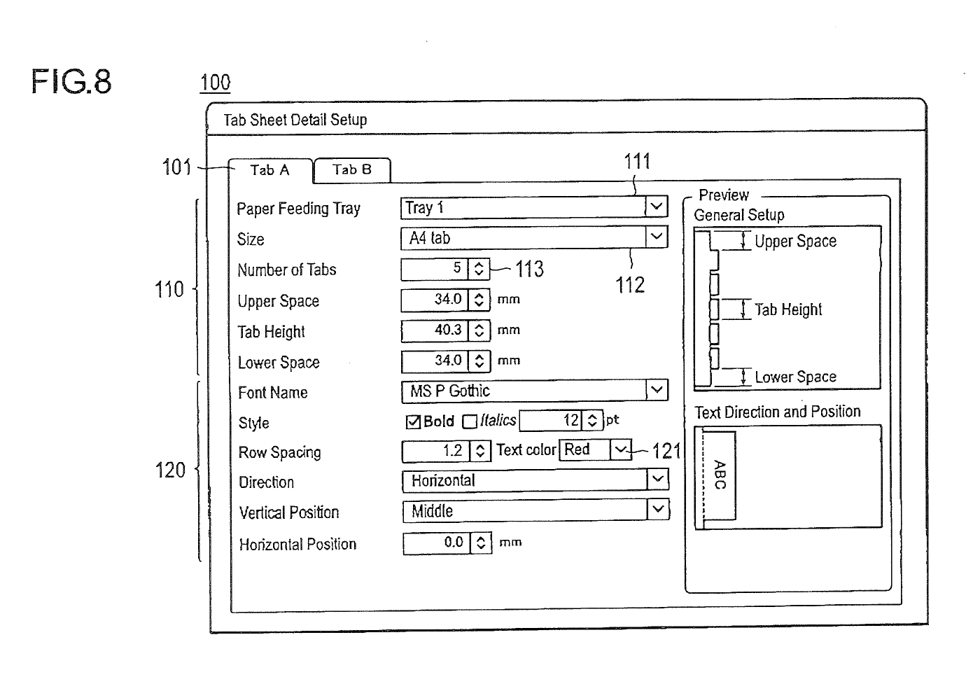

FIG. 8 is a diagram showing an example of a tab sheet detail setup screen to be provided for the user in the tab sheet setup process.

The tab sheet detail setup screen 100 has a screen switching section 101. By clicking “Tab A” on the screen switching section 101, the user is able to perform the detail setup (initial setup) for the first tab sheet group to be used for segmenting a document by the first segmentation unit (in the present embodiment, the chapter tab sheet group used for segmenting the document by a “chapter” segmentation unit). Also, by clicking “Tab B” on the screen switching section 101, the user is able to perform the detail setup (initial setup) for the second tab sheet group to be used for segmenting the document by the second segmentation unit which is a segmentation unit finer than the first segmentation (in the present embodiment, the subchapter tab sheet group used for segmenting the document by “subchapter” segmentation unit).

Also, the tab sheet detail, setup screen 100 comprises a tab sheet type specifying section 110 for specifying tab a sheet type. The tab sheet type specifying section 110 comprises a sheet feed tray specifying section 111 for specifying a sheet feed tray that feeds tab sheets, a size specifying section 112 for specifying a tab sheet size, and the tab number specifying section 113 for specifying the number of tab sheets each of which has a different tab position in one set of tab sheets.

Also, the tab sheet detail setup screen 100 comprises a tab print setup section 120 for setting up the items related to printing on the tabs of the tab sheets. The tab print setup section 120 comprises a combo box 121 for accepting user's input for setting up the items related to the print colors to be applied to the tabs of the tab sheets. In the present embodiment, the item related to print colors is the colors of character to be printed on the tabs of the tab sheets.

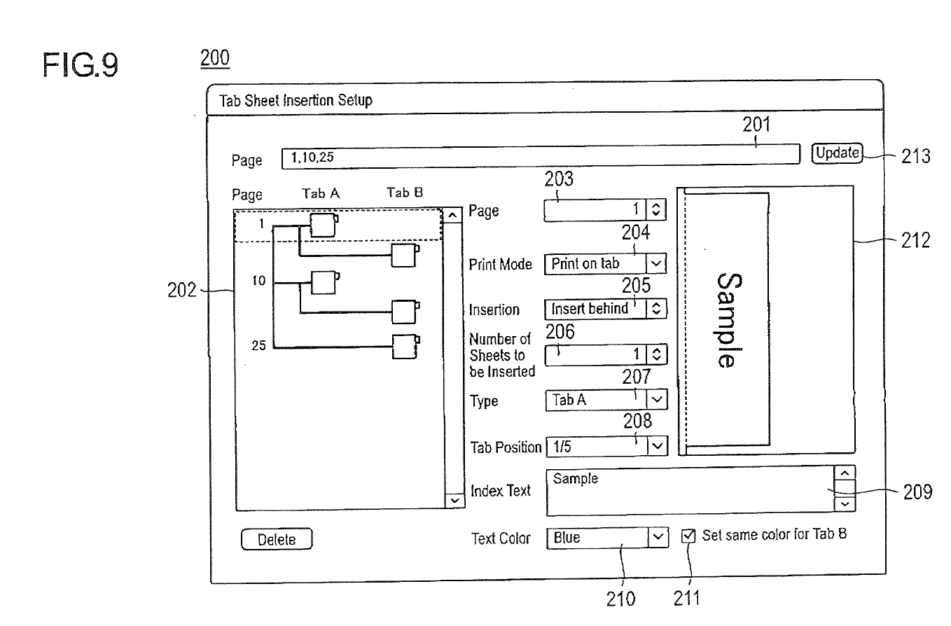

FIG. 9 is a diagram showing an example of a tab sheet insertion setup screen to be provided for the user in the tab sheet setup process.

A tab sheet insertion setup screen 200 comprises the following; an edit box 201 for specifying a page to which a tab sheet is inserted, a preview section 202 for displaying the layout of a tab sheet, an edit box 203 for specifying a page the user intends to manipulate, a combo box 204 for selecting the print configuration for printing on a tab sheet, a combo box 205 for selecting the insertion position of a tab sheet, an edit box 206 for specifying the number of tab sheets to be inserted, a combo box 207 for selecting the type of a tab sheet to be used, and a combo box 208 for selecting the tab position (index position) of a tab sheet to be used.

Also, the tab sheet insertion setup screen 200 comprises a text box 209 for entering characters to be printed on the tab (index) of a tab sheet, and a combo box 210 for accepting the user's input for setting the items related to a print color to be applied to each chapter tab sheet out of the chapter tab sheet group. In the present embodiment, the item related to print colors is the colors of characters to be printed on the tabs of the tab sheets. Here, the values to be entered in the combo box 210 of FIG. 9 are to be applied in preference over the values entered in the combo box 121 of FIG. 8.

The tab sheet setup screen 200 comprises a check box 211 a preview section 212; wherein the check box 211 functions as the identical color specifying section for accepting the user's instruction to specify the print color to be applied to the “Tab B” (subchapter tab sheet), which is identical to the print color specified for “Tab A” (chapter tab sheet) used for the “chapter” that comprises the “subchapter,” for which the said subchapter tab sheet is used; and wherein the preview section 212 is for checking the characters the user has entered.

FIG. 9 shows that the numeral “1” is specified as the page the user wishes to manipulate in the edit box 203, and that the tab sheet of the particular page is highlighted on the preview section 202. Alternatively, the preview section 202 can be constituted in so as to allow a plurality of tab sheets to be selected (highlighted) and specified as a group. The mark “213” shown in the above diagram represents a button for updating the display in the preview section 202.

As described above, the setup processes related to tab sheets are performed using the tab sheet detail setup screen 100 and the tab sheet insertion setup screen 200.

Next, the tab print color setup process for setting up print colors to be applied to tab sheets will be described referring to FIG. 10. The tab print color setup process is done as a part of the setup processes related to tab sheets of the print setup process (S102).

First, a tab sheet information table is generated based on the data entered by the user via the tab sheet insertion setup screen 200 (the edit box 201, and the combo box 207) of FIG. 9.

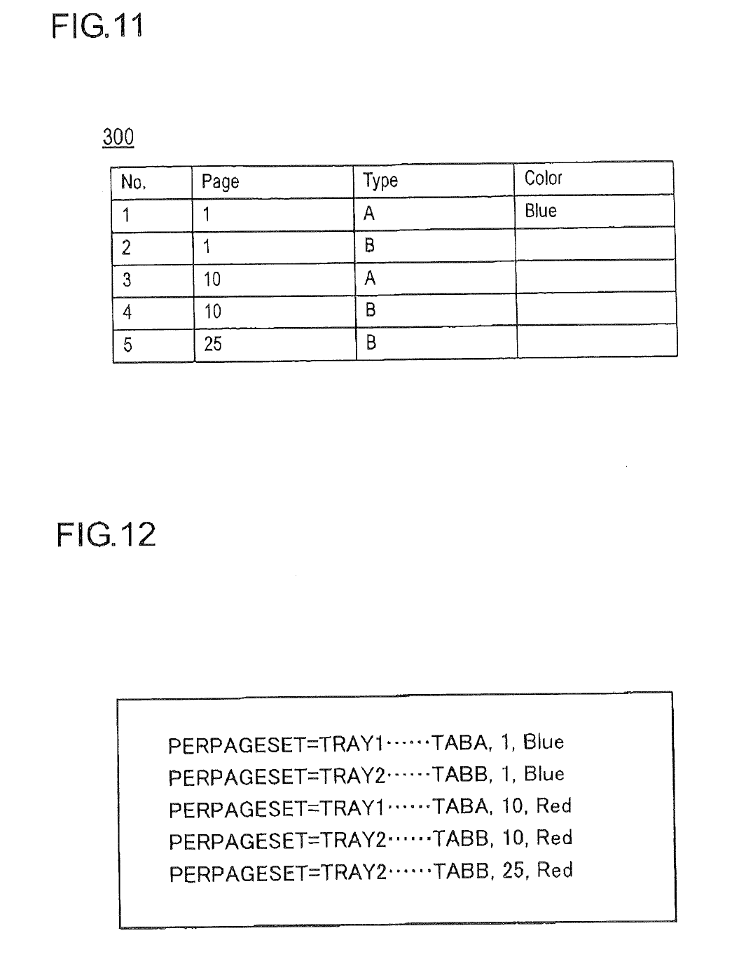

FIG. 11 is a diagram showing an example of the tab sheet information table. A tab sheet table 300 comprises columns for a tab sheet number (No.), a page to which a tab sheet is inserted (Page), a type of tab sheet to be used (Type), and a color of characters to be printed on the tabs of tab sheets (Color).

Then, the information on the type of tab sheet (Type) specified in No. 1 is acquired from the tab sheet information table 300 (S202).

In the step S203, it is determined whether the type of tab sheet in focus is “Tab A” or not.

If the tab sheet type is determined to be “Tab A” (S203: Yes), the character color information of “Tab A” is acquired and saved (S204). That is, the color information of the characters to be printed on the tab of “Tab A,” that was entered by the user via the combo box 210 of FIG. 9, is acquired and stored in the tab sheet information table 300.

On the other hand if the tab sheet type is determined to be not “Tab A” (S203: No), i.e., if it is determined to be “Tab B,” the setup information on whether it is a color identical to that of “Tab A” or not is acquired (S205). That is, the setup information is acquired based on whether or not a check input in the check box 211 exists, the setup information being whether or not the print color to be applied to the “Tab B” (subchapter tab sheet) is set identical to the print color set for “Tab A” (chapter tab sheet) which is used for the “chapter” that comprises the “subchapter” for which the subchapter tab sheet is used.

In step S206, it is determined whether or not the setup information acquired confirms that it is an identical color to that of “Tab A.” If the setup information acquired confirms that it is not an identical color to that of “Tab A” (S206: No), the program proceeds to step 5210.

If the setup information acquired confirms that it is an identical color to that of “Tab A” (S206: Yes), then a search for the tab sheet to which “Tab A” is applied is performed on the tab sheet information table 300 in the direction from its own tab sheet number (No.) toward younger tab sheet number (No.) (S207).

In step S208, it is determined as a result of the search whether the corresponding “Tab A” exists or not. If it is determined that the corresponding “Tab A” does not exist (S206: No), the program proceeds to step S210.

If it is determined that the corresponding “Tab A” exists (S208: Yes), the information of the color identical to the print color specified for the searched “Tab A” is acquired and assigned as the print color to be applied to “Tab B” (S209).

In this case, the values of the items related to the print color to be applied to the subchapter tab sheet are made to match with the values of the items related to the print color specified to the chapter tab sheet that is used for the “chapter” that comprises the “subchapter” for which the said subchapter tab sheet is used.

On the other hand, in step 5210, the print color that is set as the initial value the user entered via the combo box 121 of FIG. 8 is assigned as the print color to be applied to the “Tab B.”

In this case, the values of the items related to the print color to be applied to the tab sheet are set for each type of tab sheet. Here, it is possible to perform a process to prohibit the same color from being entered for both “Tab A” and “Tab B” in the combo box 121 of FIG. 8. As a result, it possible for, the same print color to be specified for the same type of tab sheets while different print colors are specified for different types of tab sheets.

In step S211, it is determined whether the next tab sheet number (No.), i.e., the next record, in the tab sheet information table 300 exists or not.

If the next tab sheet number (No.) exists (S211: Yes), the information of the sheet type specified for the next tab sheet number (No.) is acquired (S212), and program returns to the step S203.

If the next tab sheet number (No.) does not exist (S211: No), it is determined that all the processes related to the tab sheet number (No.) in the tab sheet information table 300 are completed, and the process of FIG. 10 is terminated.

Going back to FIG. 7, if the print setup operation is completed (S103: Yes), and the print instruction by the user has been received, then PDL data is generated by transforming the document file prepared with an application (S104). On the other hand, if the print instruction has not been received from the user (S103: No), the program returns to step S102.

Here, in the PDL data, the setup information related to the tab sheet is described as the command data. The setup information related to the tab sheet includes the print color setup information applied to the tab sheet. FIG. 12 is a diagram showing an example of tab sheet setup information.

Setup information related to print setup other than the setup related to the tab sheet is also described as command data in the PDL data.

Then, in step S105, the PDL data prepared is transmitted as a print job to the printer controller 2 of the printing system 4 via the network 5.

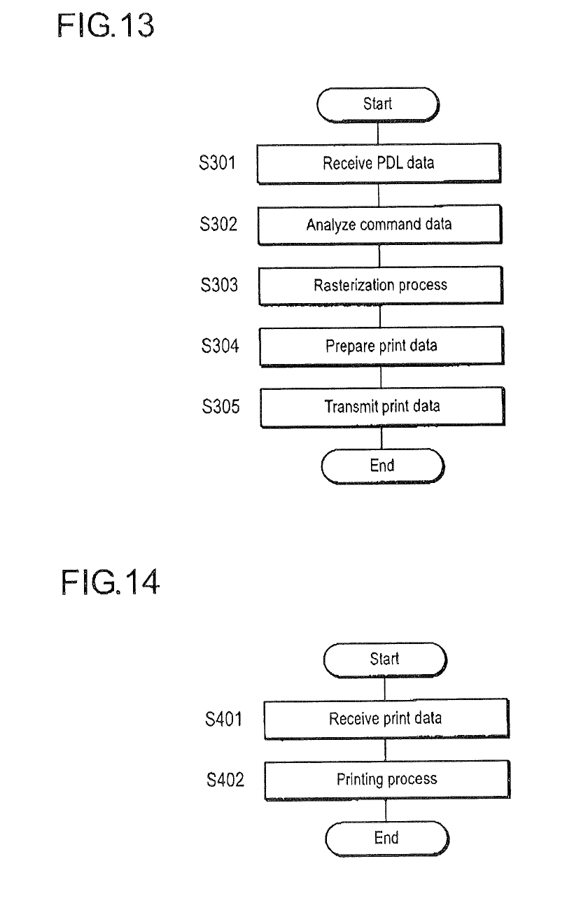

Next, referring to FIG. 13, the job process in the printer controller 2 will be described. The algorithm shown in the flowchart of FIG. 13 is stored as a program in a memory section such as a hard disk 24 of the printer controller 2 and performed by the CPU 21.

First, the printer controller 2 receives the PDL data from the PC1 (step S301), and the command data described in the PDL data is analyzed (S302). Here, the setup information related to the tab sheet is identified as the command data is analyzed.

Then, the received PDT, data is rasterized in order to obtain bitmap data, which is bitmap type image data (S303).

And, print data is generated by adding header information comprising setup information related to the tab sheet to the bitmap data obtained in step S303 (S304), and said print data is transmitted to the printer 3 (S305).

Next, referring to FIG. 14, the job process in the printer 3 will be described. The algorithm shown in the flowchart of FIG. 14 is stored as a program in a memory section such as the ROM 32 of the printer 3 and performed by the CPU 31.

The printer 3 receives the print data from the printer controller 2 (step S401). Then, the printer 3 performs the printing process (S402). When the printing process starts, the header information is analyzed first. And, as normal printing is processed page by page, a specified tab sheet is supplied from a specified supply tray at the page where a tab sheet insertion has been specified. For the tab sheet supplied from the supply tray, printing is performed based on the setup information related to the tab sheet.

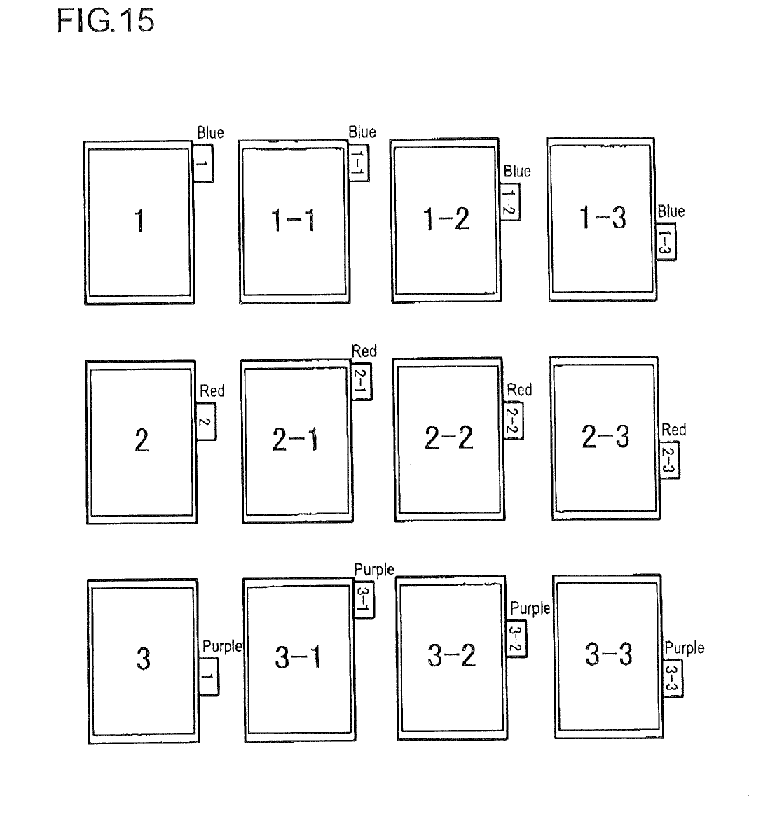

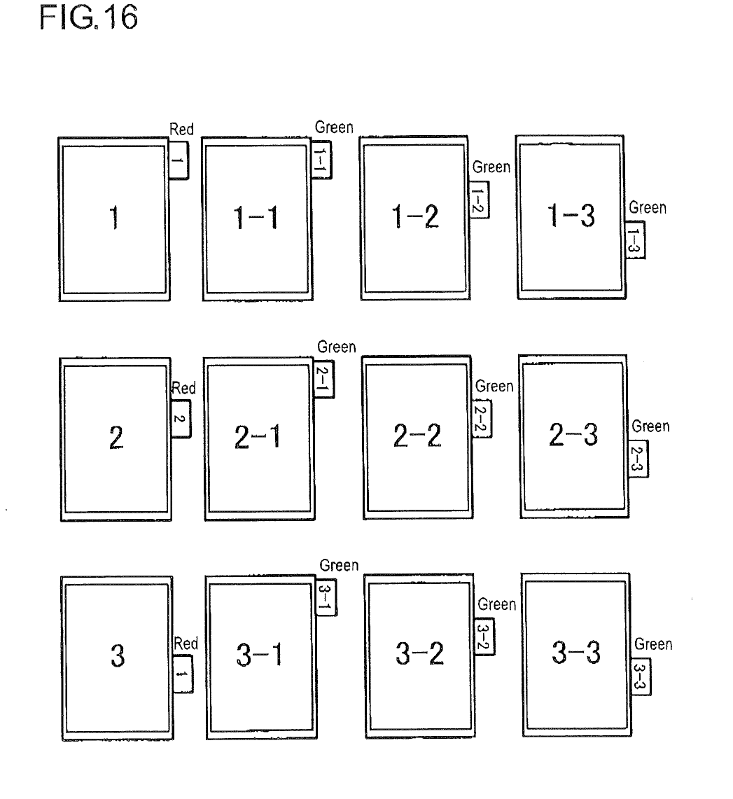

FIG. 15 is a diagram showing an example of print output result when the colors of the chapter tab sheets and of the subchapter tab sheets used in the same chapter are set to an identical color. In FIG. 15, “1,” “2,” and “3” represent chapter tab sheets, while “1-1” through “1-3,” “2-1” through “2-3,” and “3-1” through “3-3” represent subchapter sheets (same for FIG. 16). Also, the color names shown next to tabs in the FIG. 15 indicate the colors of the characters printed on the tabs (same for FIG. 16). This print output result is obtained through the processes of the steps S204 and S209.

FIG. 16 is a diagram showing an example of print output result when the print colors to be applied to the same type of tab sheets are set to an identical color. This print output result is obtained through the setup processes of the steps S204 and S210.

As described above, in the present embodiment, when a user's instruction is received in the check box 211 which functions as the identical color specifying section, the values of the items related to the print color to be applied to the subchapter tab sheet are matched with the values of the items related to the print color specified for chapter tab sheets to be used for the “chapter” that comprises the “subchapter” for which said tab sheet is used.

Thus, the values of the items related to the print color applied to the chapter tab sheet and the subchapter tab sheet to be used in the same “chapter” are set to the same values so that the visual recognition of the tab sheets by the user can be enhanced.

Hence, even when using respective tab sheets for a plurality of segmentation units such as “chapter” and “subchapter” for example, the user can easily grasp at glance the composition of a document segmented by each tab sheet.

The present invention is not limited to the embodiment described above and can be modified in various forms within the scope of the claims.

For example, it is possible to configure so as to perform the control to cause the values of the items related to the print color applied to the subchapter tab sheet to be matched with the values of the items related to the print color specified for chapter tab sheets to be used for the “chapter” that comprises the “subchapter” for which said tab sheet is used without having to receive a user's instruction in the check box 211 that functions as the identical color specifying section.

Moreover, in the above-mentioned embodiment, although the color of characters to be printed on the tab of a tab sheet is discussed as an item related to a print color, the present invention is not limited to it. In the present invention, the item related to a print color can be at least one of the followings; the color of characters to be printed on the tab of the tab sheet, the background color (background of characters) to be printed on the tab of the tab sheet, and the color of a frame (frame surrounding the characters) to be printed on the tab of the tab sheet.

Moreover, in the above-mentioned embodiment, although the printer controller 2 analyzes the setup information of the print color applied to the tab sheet described as command data and performs the color setup process, the present invention is not limited to it. In the present invention, it may be configured such that the PC 1 (printer driver) generate an image data based on the setup performed via the setup screen related to the tab sheet, and the printing process for the tab can be performed based on such image data.

Also, in the above-mentioned embodiments, although the case in which two types of tab sheets are inserted was described, the present invention is applicable to a case inserting three or more types of tab sheets. That is, although “chapter” and “subchapter” were used as examples of breakpoints in a document, the present invention is not limited to it. One breakpoint of a document can consists of two units such as “clause” and “chapter” or can consists of three or more units such as “clause,” “chapter,” and “subchapter.”

Alternatively, in the above-mentioned embodiment, although the case in which the process of setting up tab sheets was performed by the printer driver was described, it can be performed by an application instead of the printer driver.

Alternatively, in the above-mentioned embodiment, although the case of performing the setup related to tab sheets via the setup screens displayed on the display 15 of the PC 1, the present invention is not limited to it. In the present invention, the setup related to tab sheets can also be performed using the setup screens displayed on the operating panel 34 of the printer 3.

Alternatively, in the above-mentioned embodiment, although the case of a configuration was described in that the printing system 4 is divided into the printer controller 2 and the printer 3, both of which are locally connected, the printer controller 2 can be built into the printer 3.

Alternatively, in the above-mentioned embodiment, although a printer is implemented as the image forming apparatus, the invention is not limited to it. The present invention is applicable to an image forming apparatus such as MFP (Multi-Function Peripheral) and a copying machine as well.

The means and method of conducting various processes in the print setup device according to the present embodiment can be realized by means of a dedicated hardware circuit, or a programmed computer. Said program can be provided either by a computer readable recording medium such as a flexible disk and a CD-ROM, or by online via a network such as the Internet. In this case, the program recorded on the computer readable recording medium is ordinarily transferred to and stored in a memory section such as a hard disk. Moreover, said program can also be provided as independent application software or can be embedded into the software of the print setup device as a part of its function.

What is claimed is:

1. A print setup device comprising:
a print color input section that accepts a user's instruction for setting up items related to print colors to be applied to each first tab sheet of a first tab sheet group to be used in order to segment a document by a first segmentation unit; and
a control section that executes an identical color setup control in order to match an item value related to the print color to be applied to second tab sheets of a second tab sheet group with the item value related to the print color to be applied to said first tab sheets to be used for said first segmentation unit that comprises a second segmentation unit for which said second tab sheets are used; wherein said second tab sheet group is used for segmenting the document by said second segmentation unit finer than said first segmentation unit.

2. The print setup device as claimed in claim 1 further comprising:
an identical color specifying section to receive a user's instruction for setting the print color to be applied to said second tab sheets to a color identical with the print color applied to said first tab sheets, which are used for said first segmentation unit; said first segmentation unit comprising said second segmentation unit for which said second tab sheets are used, wherein
said control section executes said identical color control setup control when said user's instruction is received at said identical color specifying section.

3. The print setup device as claimed in claim 1, wherein
the item related to said print color includes at least one of the colors which include a color of characters to be printed on the tab of the tab sheet, a background color to be printed on the tab of the tab sheet, and a frame color to be printed on the tab of the tab sheet.

4. The print setup device as claimed in claim 1, wherein
said first segmentation unit is a chapter, and said second segmentation unit is a subchapter.

5. A computer readable recording medium storing a control program for causing a print setup device to execute a process comprising the steps of:
(a) providing a user with a print color input section that accepts a user's instruction for setting up items related to print colors to be applied to each first tab sheet of a first tab sheet group to be used in order to segment a document by a first segmentation unit; and
(b) executing an identical color setup control in order to match an item value related to the print colors to be applied to second tab sheets of a second tab sheet group with an item value related to the print color to be applied to said first tab sheets to be used for said first segmentation unit that comprises a second segmentation unit for which said second tab sheets are used; wherein said second segmentation tab sheet group is used for segmenting the document by said second segmentation unit finer than said first segmentation unit.

6. The computer readable recording medium as claimed in claim 5, wherein said print setup process further comprises the step of;
(c) providing an identical color specifying section to receive a user's instruction for setting the print color to be applied to said second tab sheets to a color identical with the print color applied to said first tab sheets, which are used for said first segmentation unit; said first segmentation unit comprising said second segmentation unit for which said second tab sheets are used, and
when said user's instruction is received at said identical color specifying section, said identical color, setup control is executed in the step (b).

7. The computer readable recording medium as claimed in claim 5, wherein
the item related to said print color includes at least one of the colors which include a color of characters to be printed on the tab of the tab sheet, a background color to be printed on the tab of the tab sheet, and a frame color to be printed on the tab of the tab sheet.

8. The computer readable recording medium as claimed in claim 5, wherein
said first segmentation unit is a chapter, and said second segmentation unit is a subchapter.

9. A print setup method comprising the steps of:
(a) providing a user a print color input section that accepts a user's instruction for setting up items related to print colors to be applied to each first tab sheet of a first tab sheet group to be used in order to segment a document by a first segmentation unit; and
(b) executing an identical color setup control in order to match an item value related to the print color to be applied to second tab sheets of the second tab sheet group with the item value related to the print color to be applied to said first tab sheets to be used for said first segmentation unit that comprises a second segmentation unit for which said second tab sheets are used; wherein said second tab sheet group is used for segmenting the document by said second segmentation unit finer than said first segmentation unit.

10. The print setup method as claimed in claim 9 further comprising the step of:
(c) providing the user with an identical color specifying section to receive a user's instruction for setting the print color to be applied to said second tab sheets to a color identical with the print color applied to said first tab sheets, which are used for said first segmentation unit; said first segmentation unit comprising said second segmentation unit for which said second tab sheets are used, and
when said user's instruction is received at said identical color specifying section, said identical color control setup control is executed in the step (b).

11. The print setup method as claimed in claim 9, wherein
the item related to said print color includes at least one of the colors which include a color of characters to be printed on the tab of the tab sheet, a background color to be printed on the tab of the tab sheet, and a frame color to be printed on the tab of the tab sheet.

12. The print setup method as claimed in claim 9, wherein
said first segmentation unit is a chapter, and said second segmentation unit is a subchapter.
